(19) United States
(12) Patent Application Publication
(10) Pub. No.: US 2020/0125054 A1
(43) Pub. Date: Apr. 23, 2020

(54) POWER MANAGEMENT USING PRESSURE AMPLIFICATION

(71) Applicant: Energy Harbors Corporation, Inc., Saratoga, CA (US)

(72) Inventor: Shankar Ramamurthy, Saratoga, CA (US)

(21) Appl. No.: 16/724,922

(22) Filed: Dec. 23, 2019

Related U.S. Application Data
(63) Continuation-in-part of application No. 16/378,243, filed on Apr. 8, 2019.
Application No. 16/378,243 is a continuation-in-part of application No. 16/118,886, filed on Aug. 31, 2018.
(60) Provisional application No. 62/916,449, filed on Oct. 17, 2019.
(60) Provisional application No. 62/838,992, filed on Apr. 26, 2019.
(60) Provisional application No. 62/795,133, filed on Jan. 22, 2019.
(60) Provisional application No. 62/795,140, filed on Jan. 22, 2019.
(60) Provisional application No. 62/784,582, filed on Dec. 24, 2018.
(60) Provisional application No. 62/679,051, filed on Jun. 1, 2018.
(60) Provisional application No. 62/654,718, filed on Apr. 9, 2018.
(60) Provisional application No. 62/654,859, filed on Apr. 9, 2018.
(60) Provisional application No. 62/552,747, filed on Aug. 31, 2017.
(60) Provisional application No. 62/645,859, filed on Mar. 21, 2018.

(51) Int. Cl. G05B 19/042; H02J 15/00; F04D 25/06

(52) U.S. Cl. CPC G05B 19/042; G05B 2219/25257; F04D 25/06; H02J 15/00

(57) ABSTRACT

Disclosed techniques include power management using pressure amplification. An energy conversion requirement for a fluid-based energy management system is determined. The energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The pump-turbine subsystem is operated at an optimal pressure-performance point for the pump-turbine subsystem. The energy that was transformed is delivered, where the delivering is accomplished using the pump-turbine subsystem connected to one or more pressure amplification pipes. The energy management system is operated by an energy management control system. The energy management control system controls coupling of the energy, the pump-turbine subsystem, and the one or more pressure amplification pipes.

### RELATED APPLICATIONS

This application claims the benefit of U.S. provisional patent applications “Power Management Using Pressure Amplification” Ser. No. 62/784,582, filed Dec. 24, 2018, “Energy Management Using a Converged Infrastructure” Ser. No. 62/795,140, filed Jan. 22, 2019, “Energy Management Using Electronic Flywheel” Ser. No. 62/795,133, filed Jan. 22, 2019, “Energy Transfer Through Fluid Flows” Ser. No. 62/838,992, filed Apr. 26, 2019, and “Desalination Using Pressure Vessels” Ser. No. 62/916,449, filed Oct. 17, 2019.

This application is also a continuation-in-part of U.S. patent application “Energy Storage and Management Using Pumping” Ser. No. 16/378,243, filed Apr. 8, 2019, which claims the benefit of U.S. provisional patent applications “Modularized Energy Management Using Pooling” Ser. No. 62/654,718, filed Apr. 9, 2018, “Energy Storage and Management Using Pumping” Ser. No. 62/654,859, filed Apr. 9, 2018, “Power Management Across Point of Source to Point of Load” Ser. No. 62/679,051, filed Jun. 1, 2018, “Energy Management Using Pressure Amplification” Ser. No. 62/784,582, filed Dec. 24, 2018, “Energy Management Using a Converged Infrastructure” Ser. No. 62/795,140, filed Jan. 22, 2019, and “Energy Management Using Electronic Flywheel” Ser. No. 62/795,133, filed Jan. 22, 2019.

The U.S. patent application “Energy Storage and Management Using Pumping” Ser. No. 16/378,243, filed Apr. 8, 2019, is also a continuation-in-part of U.S. patent application “Energy Management with Multiple Pressurized Storage Elements” Ser. No. 16/118,886, filed Aug. 31, 2018, which claims the benefit of U.S. provisional patent applications “Energy Management with Multiple Pressurized Storage Elements” Ser. No. 62/552,747, filed Aug. 31, 2017, “Modularized Energy Management Using Pooling” Ser. No. 62/654,718, filed Apr. 9, 2018, “Energy Storage and Management Using Pumping” Ser. No. 62/654,859, filed Apr. 9, 2018, and “Power Management Across Point of Source to Point of Load” Ser. No. 62/679,051, filed Jun. 1, 2018.

Each of the foregoing applications is hereby incorporated by reference in its entirety.

### FIELD OF ART

This application relates generally to energy management and more particularly to power management using pressure amplification.

### BACKGROUND

Government agencies, energy producers, and responsible energy consumers enforce, initiate, and practice energy conservation measures, respectively. Conservation techniques can be simple and effective habits such as turning off unneeded lights when leaving a room, or adjusting the thermostat lower in winter and higher in summer. Purchasing energy-efficient appliances or vehicles is another common approach. Despite these conservation efforts, energy demands of all types continue to increase and often exceed energy supply. Growth of towns, cities, states, and countries increases the demand for energy of all kinds, resulting in what is now considered by many analysts to be an energy crisis. There are many root causes for the energy demand increases. Overconsumption of energy imposes strains on natural resources ranging from fossil fuels to renewables, or biofuels such as wood chips, resulting increased environmental pollution and fuel shortages. Population growth, and the desire to provide electricity to previously underserved or unserved regions, put further strains on energy sources. Population growth increases the numbers of energy consumers who want to perform daily tasks such as washing, cooking, entertaining, illuminating, and heating and cooling of their houses and apartments. Beyond the domestic use, increases in energy demand result from public projects and expanded economic activities such as manufacturing, transportation, and retail, among many.

Energy distribution problems are a primary hindrance to solving the energy crisis. Inadequate energy distribution infrastructure, and aging energy generation sources and equipment, cannot keep pace with the new and emerging energy demands. Renewable energy options remain largely unexplored or underdeveloped. Landowners and others who live adjacent to proposed energy generation sites often wage vehement resistance to the construction of windmills, solar farms, or wood burning plants. Further, when plans can be made to construct new energy producing facilities, distribution of the energy is stymied by the poor distribution infrastructure. Commissioning of new energy generation facilities remains a nearly intractable goal. Legal wrangling, construction delays, pollution mitigation requirements, overwhelming costs, or war, have prevented, halted, or delayed bringing new energy generation facilities online. Energy wastage is another major culprit. Aging appliances or manufacturing equipment, incandescent light bulbs, and poor building insulation and air sealing, all waste energy in comparison to their modern counterparts.

To meet the increases in energy demands of all types, public officials and city planners have been confronted with choosing among three broad design or policy choices: to increase energy production through building new power plants, to reduce energy demand through energy conservation measures, or to combine both of these methods. An increasingly popular energy production option is to source energy based on renewable energy production such as solar, wind, geothermal, wave action, tidal, and so on. Perhaps the primary limitation to sole reliance on renewable energy sources is the sporadic availability of these energy sources. For example, solar sources produce energy only in the presence of light. Further, the amounts of energy produced vary depending on the intensity of the light hitting the photovoltaic panels. Energy sources and energy demands must be balanced so that clean and reliable energy is consistently available to all consumers countrywide.

Energy demand has been largely driven by the growth and development of municipalities, counties, states, and countries. The energy demands for electricity and fuel have seen some of the most dramatic expansions. The increases in the living standards in rural areas, including bringing electrical and communications infrastructure to these areas, or the expansion of transportation networks, has driven a tremendous growth in the demand for energy. Further, growing populations drive energy demand increases as those people consume energy for daily tasks that include bathing, cleaning, laundry, cooking, entertaining, illuminating, or heating and cooling of their houses or apartments. Yet more increases in energy demand result from expanded economic activities such as retail, public transportation, and manufacturing, to name only a few. To meet the increases in energy demands of all types, city planners and public officials must act. The officials and planners are confronted with choosing among three broad design or policy choices: increasing energy production by building new power plants, reducing energy demand through energy conservation, or combining both of these methods. A popular energy production option is to source energy based on renewable energy production such as solar, wind, geothermal, wave action, tidal, biogas, and so on. The primary hindrance to sole reliance on renewable energy sources is the sporadic availability of these energy sources. Further, the amounts of energy produced vary depending on the intensity of the light hitting the photovoltaic panels or the velocity of the wind impacting a wind turbine. Energy sources and energy demands must be balanced so that clean and reliable energy is consistently available to all consumers countrywide.

### SUMMARY

Energy can be produced by diverse and disparate generation sources. The difference between energy production and energy consumption typically increases or decreases over a given period of time. These differences can further depend on a timeframe such as day versus night, day of the week, manufacturing schedules, seasonal factors such as heating or cooling, and so on. The discrepancies between energy production and consumption can be significant and at times critical. The discrepancies can be correlated to time-dependent energy demands, changeable energy production capabilities such as the presence or absence of a renewable resource used to generate the energy, available capacity of commercial or grid power, the amount of standby or backup energy, and so on. To ameliorate the energy production/consumption asymmetry, energy that is in excess to demand at a given time can be stored for later use. The stored energy can be accessed when demand exceeds a given power level. Energy can be collected and stored when a renewable resource is available, when the energy available exceeds the energy needed, or even when the cost of production of the energy is relatively inexpensive. The stored energy can be used to augment available energy or instead to provide the amount of energy that is needed during periods of increased or unmet energy need. The recovery of stored energy can be applied to low-level energy demand scenarios, such as the energy needs of a house or small farm operation, or to larger scale energy needs such as the energy needs for manufacturing, or to the largest energy needs such as an energy distribution grid.

Disclosed techniques address energy management using pressure amplification. An energy conversion requirement for a fluid-based energy management system is determined, where the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes. The pump-turbine subsystem is operated at an optimal pressure-performance point for the pump-turbine subsystem. The energy conversion requirement includes operation of a pump within the pump-turbine subsystem and fluid delivery out of the one or more pressure amplification pipes. The pump is driven by electrical energy.

A computer-implemented method for energy management is disclosed comprising: determining an energy conversion requirement for a fluid-based energy management system, wherein the energy management system includes a pump-turbine subsystem connected to one or more pressure amplification pipes; providing energy to the energy management system, based on the energy conversion requirement; transforming the energy, using the pump-turbine subsystem connected to one or more pressure amplification pipes; and delivering the energy that was transformed, wherein the delivering is accomplished using the pump-turbine subsystem connected to one or more pressure amplification pipes. Embodiments further comprise operating the pump-turbine subsystem at an optimal pressure-performance point for the pump-turbine subsystem. In embodiments, the energy conversion requirement includes operation of a pump within the pump-turbine subsystem and fluid delivery out of the one or more pressure amplification pipes. In embodiments, a first pressure amplification pipe within the one or more pressure amplification pipes comprises a rigid, mechanical connection between a first piston of a first pipe and a second piston of a second pipe. In embodiments, the mechanical connection, the first piston, and the second piston are disposed rectilinearly.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for energy management using pressure amplification.

FIG. 2 illustrates water pump energy input.

FIG. 3 shows water pump turbine output.

FIG. 4 illustrates pressure amplification pipes.

FIG. 5 shows pressure amplification pipes using reverse osmosis.

FIG. 6 is a table for pressure amplification pipes.

FIG. 7 shows energy storage and recovery.

FIG. 8 illustrates an energy internet block diagram.

FIG. 9 shows a software-defined water piston heat engine (WPHE).

FIG. 10A illustrates adiabicity in a heat transfer cycle.

FIG. 10B illustrates an isothermal heat transfer cycle.

FIG. 11 is a system diagram for energy management.

### DETAILED DESCRIPTION

This disclosure provides techniques for energy management using pressure amplification. The energy management is based on storing energy using one or more pressure amplification pipes. The presume amplification pipes can be parts of a large-scale energy storage subsystem which can store energy from one or more points of generation. The stored energy can be provided after a period of time to meet energy demands of dynamic loads. The energy that is stored can be received from diverse and disparate energy sources. Energy can be stored when the amount of energy available from the points of generation exceeds the energy demand at the time of energy generation. The energy can be stored for a period of time. The energy storage includes electrical energy storage using batteries or capacitors. The energy storage can include multiple pressurized storage elements such as compressed air storage elements. The energy storage includes the one or more pressure amplification pipes. The storage of the energy and the recovery of the energy can include use of a water piston heat engine. Managing the sourcing, storing, and transforming of energy is a complex and highly challenging task. Energy management can be influenced by many factors including the weather, wildly varying energy demand, variable pricing schemes, and so on. Energy management can be further complicated by quickly changing customer energy demands, requirements of service level agreements (SLAs), etc. Despite the growing use of renewable energy resources such as solar, wind, wave action, tidal, geothermal, biogas, and the like, two significant challenges remain: the amount of energy produced by a given renewable energy source is highly variable, and the availability of the renewable energy source is inconsistent. As an example, wind energy is only available when wind is present, solar energy only when the sun is shining, wave action energy only when there is wave action, and so on.

Energy with intermittent availability or excess energy can be stored or cached when the energy is being produced, and can be extracted at a later time when the stored energy is needed. A similar strategy can be used based on price, where energy is stored when production cost is low, then later extracted when the energy production cost is high. The stored energy can be used in combination with other energy sources such as grid power or microgrid (local) power to meet energy demands at given times. Storage can include a period of time, where the period of time can be a short-term basis or a long-term basis. Energy losses are introduced when converting energy from one energy type to another energy type. Further losses occur when storing energy, extracting energy, routing energy, etc. Minimizing the energy losses is critical to any energy storage and retrieval/recovery technique. Electrical energy storage is possible using techniques such as mature storage battery technologies, but the costs of large battery banks are prohibitive in terms of up-front cost and maintenance costs. Further, batteries are problematic for long-term storage purposes because of charge leakage.

In disclosed techniques, energy management uses pressure amplification. Energy can be stored for later use. The energy can be obtained locally using a microgrid or from farther afield using a grid. The energy can be generated using fuels such as coal, natural gas, or nuclear sources; using hydro power or geothermal energy; using renewable sources such as solar, wind, tidal, wave-action, bio-fuels or biogas; using pump-turbine sources such as compressed air, steam, or ice; using backup power sources such as diesel-generator sets; and so on. An energy conversion requirement for a fluid-based energy management system is determined, where the energy management system includes a pump-turbine subsystem connected to one or more pressure amplification pipes. The fluid-based energy management system can be part of a larger energy management system that includes large-scale energy storage subsystem. The large-scale energy storage subsystem can store electrical energy, potential energy, thermal energy, kinetic energy, etc. Energy is provided to the energy management system, based on the energy conversion requirement. The energy conversion requirement can include operation of a pump within the pump-turbine subsystem and fluid delivery out of the one or more pressure amplification pipes. The pump can be driven by electrical energy. The energy conversion requirement can include fluid pressure delivered into at least one pipe of the one or more pressure amplification pipes and turbine operation. The turbine operation is used to drive electrical energy generation. The energy is transformed using the pump-turbine subsystem connected to one or more pressure amplification pipes. The energy can be transformed to pressure, to liquid energy, to gaseous energy, and so on. The energy that was transformed is delivered, where the delivering is accomplished using the pump-turbine subsystem connected to one or more pressure amplification pipes. The pump-turbine can include an integrated pump-turbine component, separate pump and turbine components, etc. The delivered energy can be in the form of electrical energy.

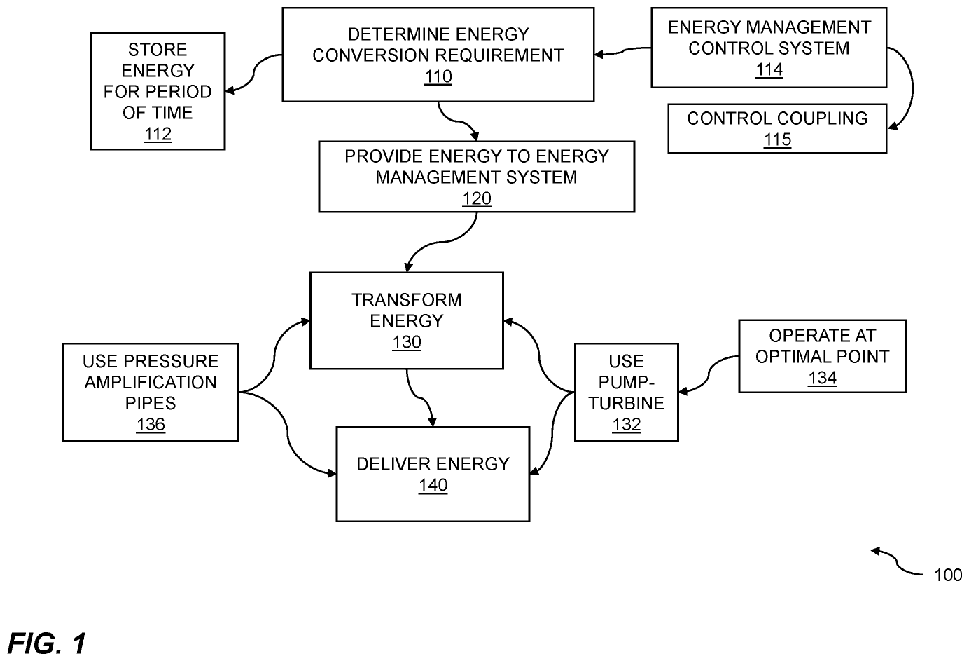

FIG. 1 is a flow diagram for energy management using pressure amplification. Energy storage and management can be based on a fluid-based energy management subsystem. The fluid-based energy management subsystem can store various forms of energy such as electrical energy by storing the energy in pressure amplification pipes. The energy can be stored based on a pressure amplifier which can use high pressure or low pressure. The energy can be stored using liquid energy transfer, where the liquid can include a solvent such as water, liquid air, and the like. The energy can be stored using gaseous energy transfer, where the gas can include a vacuum, air, or a gas such as Freon. The fluid-based energy management subsystem can be part of a large energy storage subsystem, where the energy storage subsystems can include multiple batteries or capacitors, pressurized storage elements such as high-pressure water, pressurized air, steam, ice-water slurry, and the like. An energy conversion requirement for a fluid-based energy management system is determined, where the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

A flow 100 for energy management using pressure amplification is shown. Pressure amplification can be accomplished using one or more pressure amplification pipes 136. Energy, such as electrical energy from a traditional electrical grid, energy from renewable sources, and so on, can be stored. Thermal energy, mechanical energy, pressure, and other forms of energy can also be stored. The energy can be transformed into an energy format which can be stored for a length of time. Energy management can be used for storing, retrieving, or extracting energy from an energy storage subsystem. The energy storage subsystem can be a large-scale energy storage subsystem or a small-scale energy storage subsystem. The energy storage subsystems can be based on battery storage, capacitor storage, inductive storage, compressed air storage, steam or ice storage, ice-water slurry, and so on. The energy storage subsystem can include a pump-turbine storage subsystem. A pump-turbine storage subsystem can include energy storage elements such as high-pressure chambers, compression-expansion chambers, compressed air chambers, and so on. A pump-turbine energy management system can be implemented within a non-productive oil well infrastructure, unused salt caverns, aquifers, large cavities underground, or porous rock structures capable of holding air or water under pressure. The energy storage subsystems can include pressure amplification pipes. The storage elements of an energy storage subsystem can store various energy types including electrical energy, thermal energy, kinetic energy, mechanical energy, hydraulic energy, and so on.

The flow 100 includes determining an energy conversion requirement 110 for a fluid-based energy management system. The energy conversion requirement can include an amount of energy required, and anticipated amount of energy required, an amount of energy dictated by a service level agreement, and so on. The energy management system includes a pump-turbine subsystem connected to one or more pressure amplification pipes. The one or more pressure amplification pipes can be used to amplify or deamplify fluid pressure based on relative cross-sectional dimensions of the pressure amplification pipes. In embodiments, the energy conversion requirement can include operation of a pump within the pump-turbine subsystem and fluid delivery out of the one or more pressure amplification pipes. The pump can be driven by mechanical energy or another energy source. In embodiments, the pump is driven by electrical energy. The energy conversion requirement can be based on other factors or parameters such as an amount of pressure. In embodiments, the energy conversion requirement can include fluid pressure delivered into at least one pipe of the one or more pressure amplification pipes and turbine operation. The pressure can include a high pressure, a low pressure, etc. In embodiments, the fluid pressure delivered can include a vacuum. The turbine operation can be used for moving fluids or gases, for energy generation, and the like. In embodiments, the turbine operation can be used to drive electrical energy generation.

In the flow 100, the fluid-based energy management system includes storing energy for a period of time 112. The period of time for which the energy can be stored can be based on when the energy is produced, by what means the energy is produced, a possible use for the energy, and so on. In embodiments, the period of time can be a short-term basis. Storing energy for a short-term basis can include storing energy as electrical energy in capacitors, chemical energy in batteries, etc. The storing energy for a short-term basis can include storing energy using pressure amplification pipes. In embodiments, the short-term basis can be an integer number of seconds, minutes, hours, or days, where the integer number of seconds, minutes, hours, or days comprises a length of time substantially less than one week. The energy storage can include other periods of time. In embodiments, the period of time is a long-term basis. A long-term basis can include storing energy such as thermal energy collected during hot months for use during cold months. In embodiments, the long-term basis can be an integer number of weeks, months, seasons, or years, wherein the integer number of weeks, months, seasons, or years comprises a length of time substantially more than one day. In the flow 100, the energy management system is operated by an energy management control system 114. The energy management control system can include controlling subsystems, adding or removing subsystems, controlling energy storage, determining energy needs, etc. In embodiments, the energy management control system can control coupling 115 of the energy, the pump-turbine subsystem, and the one or more pressure amplification pipes.

The flow 100 includes providing energy to the energy management system 120, based on the energy conversion requirement. The energy management system can receive energy for storage and as discussed shortly, can provide energy for usage. Energy that can be stored can be obtained from a variety of sources. The energy sources can include grid power, where grid power can be generated using coal, natural gas, nuclear, hydro, and so on. The energy sources can include renewable energy sources, where the renewable energy sources can include solar, wind, wave action, tidal, geothermal, and the like. The received energy can be stored. As discussed throughout, the energy can be stored using a pump-turbine subsystem connected to the one or more pressure amplification pipes.

Various techniques can be used for the pressure amplification pipes. In embodiments, a first pressure amplification pipe within the one or more pressure amplification pipes can include a rigid, mechanical connection between a first piston of a first pipe and a second piston of a second pipe. The first pipe and the second pipe can be of a substantially similar length or dissimilar lengths. In embodiments, the first piston can be a first diameter and the second piston can be a second diameter. The second piston, for example, can have the same diameter as the first piston, a diameter that is greater than that of the first piston, or a diameter that is less than that of the first piston. In embodiments, the difference between the first diameter and the second diameter can provide a pressure amplification factor. The pressure amplification factor can be greater than one (e.g. amplification), less than one (e.g. deamplification), and so on. Using Boyle's Law and assuming constant temperature, relating the first pipe pressure and cross-sectional area to the second pipe pressure and cross-sectional area we find: P₁A₁=P₂A₂, or P₂=P₁A₁/A₂. Pressure amplifier gain=A₁/A₂. If A₂<<A₁, then pressure amplification is accomplished. If A₂>>A₁, then pressure deamplification is accomplished. The pistons can be driven by fluids, gases, and so on. In embodiments, the first piston is driven by a first fluid and the second piston is driven by a second fluid. Various types of fluids can be used. In embodiments, the first fluid can be ambient water delivered at an optimal pressure-performance point for a pump of the pump-turbine subsystem. The first fluid can be purified water. The first fluid and the second fluid can different fluids or substantially similar fluids. In embodiments, the second fluid is a vacuum. The second fluid can include ambient water, brackish water, seawater, and so on.

The flow 100 includes transforming the energy 130. The transforming the energy can include transforming energy from one energy form to another energy form. For example, the transforming the energy can include transforming energy stored using pressure amplification pipes, stored in a liquid energy, or stored in a gas energy to mechanical energy or another form of energy. The transforming the energy includes using the pump-turbine subsystem 132 connected to one or more pressure amplification pipes. The transformed energy can be used to spin a turbine, operate a pump-turbine, etc. Further embodiments include operating the pump-turbine subsystem at an optimal pressure-performance point 134 for the pump-turbine subsystem. The optimal pressure-performance point can be based on pump efficiency, fluid type or gas type, gain of a pressure amplification pipe, and so on. The flow 100 includes delivering the energy that was transformed 140. The delivering energy can include delivering mechanical energy, where the mechanical energy can be used to spin a turbine. The turbine can include a pump-turbine, a stand-alone turbine, and so on. The turbine operation can be used to drive electrical energy generation. In the flow 100, the delivering the energy that was transformed is accomplished using the pump-turbine subsystem 132 connected to one or more pressure amplification pipes. Pressure released from the pressure amplification pipes can be used to push a fluid past the turbine, a gas past the turbine, etc. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

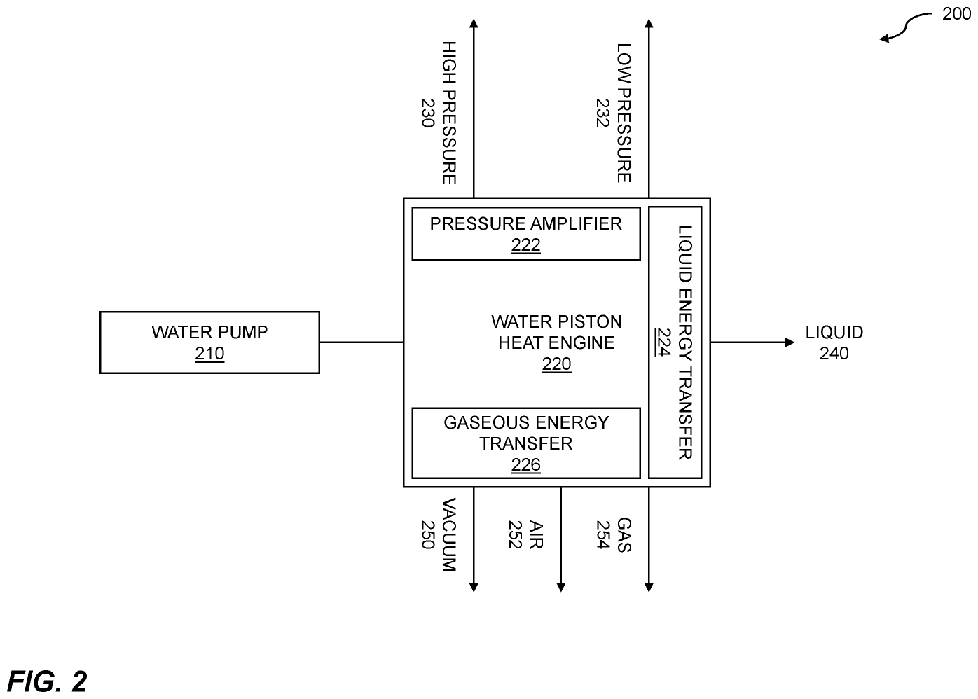

FIG. 2 illustrates water pump energy input. Input energy, including grid energy, renewable energy, and so on, can be stored based on gaseous energy transfer, liquid energy transfer, electrical energy storage, chemical energy storage, and so on. Energy can be further stored using pressure amplification, where the pressure amplification can be based on pressure amplifier pipes. The input energy can be transformed into any of a variety of storage formats using a pump-turbine subsystem. The pump-turbine subsystem can be operated by an energy management system. The energy management system can be operated by an energy management control system. The energy management control system can control coupling of the energy such as the input energy, a pump-turbine subsystem, and one or more pressure amplification pipes. Water pump input supports energy management using pressure amplification. An energy conversion requirement for a fluid-based energy management system is determined. The energy management system includes a pump-turbine subsystem connected to one or more pressure amplification pipes. The energy conversion requirement includes operation of a pump within the pump-turbine subsystem and fluid delivery out of the one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

Water pump energy input 200 can include a water pump 210. While a water pump is shown and described, the pump can include a pump for pumping gases, a pump for two phases such as gas and liquid, a pump for a slurry, and so on. The water pump can be included in a pump-turbine subsystem. The water pump can be integral to a pump-turbine component, a standalone pump, etc. The water pump can provide input energy to a water piston heat engine 220 (WPHE). A WPHE, or a liquid piston heat engine, can be used to convert the liquid or gas provided by the pump to a storage format. The WPHE can transform the input energy to a variety of energy storage formats. In embodiments, the WPHE sends energy to a pressure amplifier 222. As described throughout, the pressure amplifier can include one or more pressure amplifier pipes. The pressure amplifier pipes can provide a high pressure 230 amplifier pipe or low pressure amplifier pipe 232. In embodiments, the WPHE can send energy to storage via liquid energy transfer 224. The energy can be stored in a liquid 240 format. Liquid energy transfer can be accomplished using a heat exchanger, a heat injector, a chiller, and so on. Liquid sources can include liquefied gases such as liquid air, ice, an ice slurry, etc. One or more gases can receive energy through gaseous energy transfer 226. The WPHE can send energy to gaseous storage formats. The gaseous storage formats can include a vacuum 250, air 252, a gas 254, and so on. The gas can include a specialized gas such as Freon™. The WPHE can transform the energy that can be received from the water pump to energy for storage in a pressure amplifier, to liquid energy transfer, or to gaseous energy. The transfer can be accomplished using the mechanical energy of the water pump.

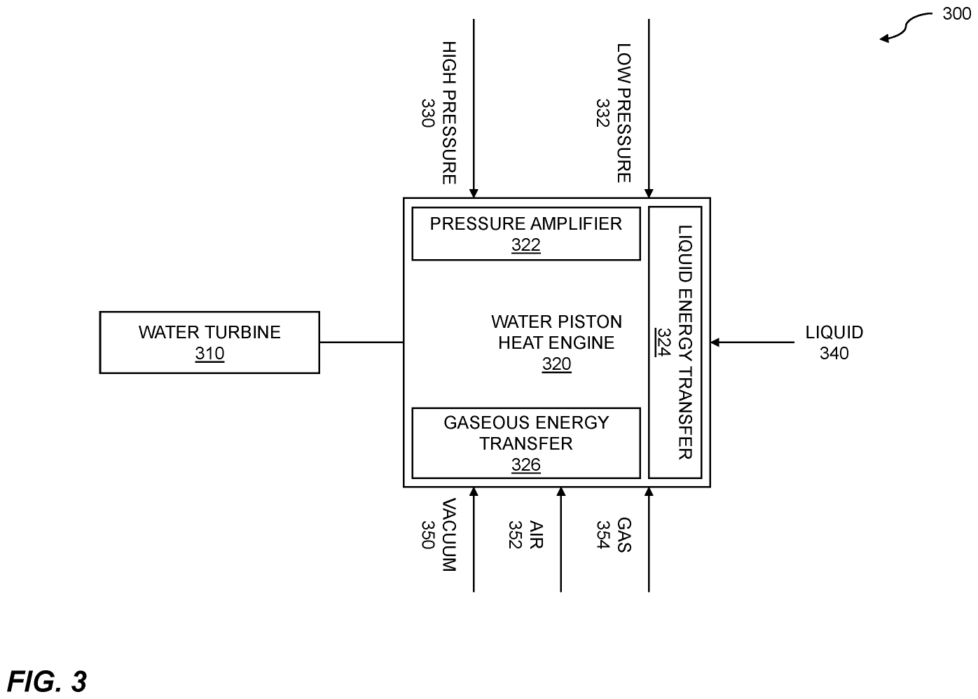

FIG. 3 shows water pump turbine output. Energy that was stored based on gaseous energy transfer, liquid energy transfer, electrical energy storage, chemical energy storage, and so on, can be transformed. The transformation of the stored energy can include transforming energy such as thermal or chemical energy into another form of energy such as mechanical energy. In embodiments, the transformation of stored energy can include transforming energy from pressure amplification, where the pressure amplification can be based on pressure amplifier pipes. The mechanical energy can be used to spin a turbine or other component to transform the mechanical energy into a further form of energy such as electrical energy. The stored energy can be transformed from any of a variety of storage formats using a pump-turbine subsystem, where the pump-turbine subsystem can be operated by an energy management system. Pump turbine output supports energy management using pressure amplification. An energy conversion requirement for a fluid-based energy management system is determined. The energy management system includes a pump-turbine subsystem connected to one or more pressure amplification pipes. The energy conversion requirement includes operation of a pump within the pump-turbine subsystem and fluid delivery out of the one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

Water pump-turbine output 300 can include a water turbine 310. While a water turbine is described, other types of turbines such as a steam turbine, a gas turbine, and so on can be used. The water turbine can be included in a pump-turbine subsystem. The water turbine can be integral to a pump-turbine component, a standalone turbine, etc. The water turbine can receive stored energy from a water piston heat engine 320 (WPHE). A WPHE, or a liquid piston heat engine, can be used to convert thermal or chemical energy to mechanical energy. The WPHE can receive energy from a variety of energy sources. In embodiments, the WPHE receives energy from a pressure amplifier 322. As described throughout, the pressure amplifier can include one or more pressure amplifier pipes. The pressure amplifier pipes can provide high pressure 330 or low pressure 332. The WPHE can receive energy from liquid 340 sources. In embodiments, the WPHE receives energy from liquid energy transfer 324. Liquid energy transfer can be accomplished using a heat exchanger, a heat injector, a chiller, and so on. Liquid sources can include liquefied gases such as liquid air. The WPHE can receive energy from gaseous sources. The gaseous sources can include a vacuum 350, air 352, a gas 354, and so on. The gas can include a specialized gas such as Freon™. One or more gases can provide energy through gaseous energy transfer 326. The WPHE can transform the energy that can be recovered from the pressure amplifier, from liquid energy transfer, or from gaseous energy transfer into mechanical energy. The mechanical energy can be used to spin the turbine, where the spinning turbine can be used to generate electrical energy.

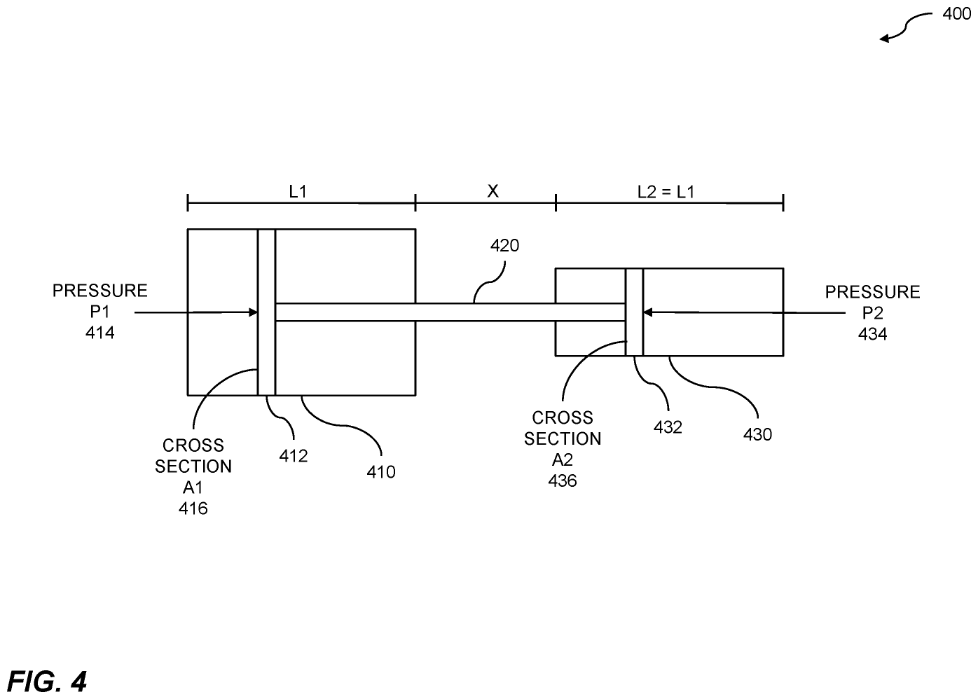

FIG. 4 illustrates pressure amplification pipes. Fluid pressure, gas pressure, etc., can be amplified using one or more pressure amplification pipes. The amplification, or deamplification, of the pressure can be accomplished using pipes of various diameters or cross-sectional areas. The fluid pressure or gas pressure can be used for storing energy. Pressurizing the fluid or the gas can be accomplished using a pump-turbine subsystem. Energy management is supported using pressure amplification. An energy conversion requirement for a fluid-based energy management system is determined, where the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

Pressure amplification can be based on pressure amplifier pipes 400. A cylinder 410 can include a piston 412. While a cylinder is shown, other geometric shapes can be used, where the geometric shapes can be based on squares, rectangles, and so on. The piston can have a cross-sectional area A1 416. The cylinder can have a length L1. A pressure P1 414 can be applied to the piston. The pressure can be applied using a fluid, a gas, and so on. The fluid or gas can be pressurized using a pump-turbine subsystem. The pump-turbine subsystem can include a combined pump-turbine component, a separate pump component and a separate turbine component, etc. In embodiments, the pump can be driven by electrical energy. The electrical energy can be obtained from grid energy sources such as coal, natural gas, nuclear, geothermal, or hydro; renewable energy sources such as solar, wind, wave action, or tidal; and so on. The piston 412 within cylinder 410 can be coupled to a second piston 432 using a coupling 420. The second piston can be included within a second cylinder 430. The second cylinder can have a cross-sectional area A2 436, and can have a length L2=L1. The coupling 420 of piston 412 and the second piston 432 can include a rod, a shaft, a pipe, and the like. The coupling has a length equal to L1+x, where x is the separation between the two cylinders. In embodiments, a first pressure amplification pipe within the one or more pressure amplification pipes comprises a rigid, mechanical connection between a first piston of a first pipe and a second piston of a second pipe.

Pressure amplification or pressure deamplification can be accomplished by choosing a differentiation between the cross-sectional areas A₁ and A₂. While two cylinders are shown, the cylinders 410 and 430 can be replaced by pipes, where the pipes can include pipes with different cross-sectional areas. The pipes can include pressure amplification pipes, pressure deamplification pipes, etc. A ratio between the cross-sectional area A1 416 and cross-sectional area A2 436 can be used to determine pressure differences between P1 414 and P2 434. Using Boyle's Law, P₁A₁=P₂A₂, or P₂=P₁A₁/A₂. Pressure amplifier gain=A₁/A₂. If A₂<<then pressure amplification is accomplished. If A₂>>A₁, then pressure deamplification is accomplished.

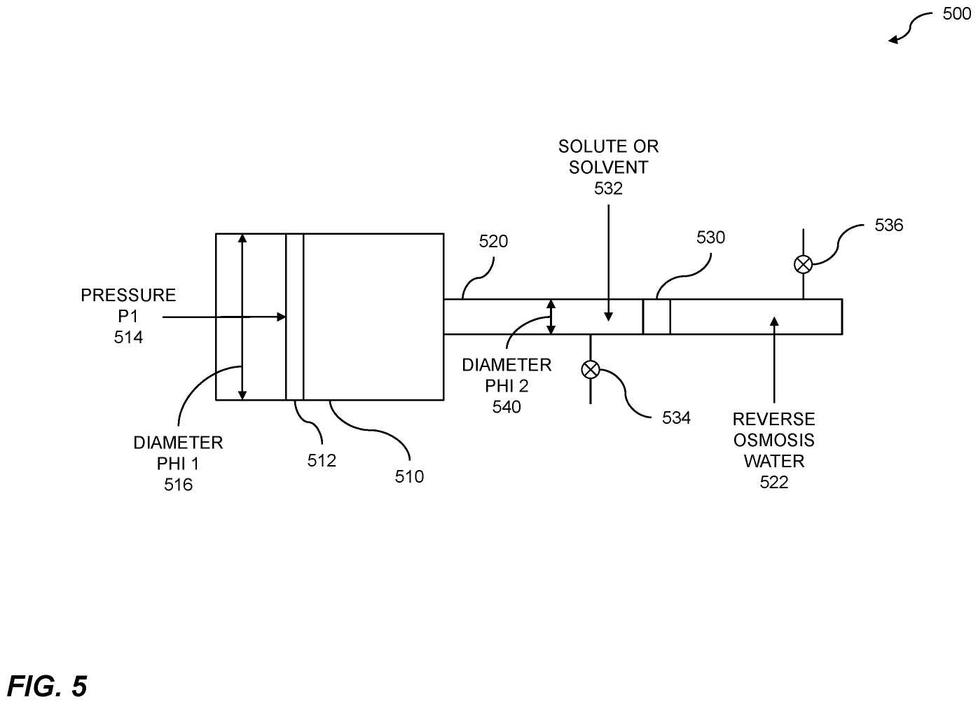

FIG. 5 shows pressure amplification pipes using reverse osmosis. As discussed throughout, pressure amplification or pressure deamplification can be accomplished by pumping fluids, gases, and so on, using pipes such as pressure amplification pipes. The pressure amplification pipes comprise pipes of differing diameters. In embodiments, the one or more fluids or gases that are pumped can enable reverse osmosis. The reverse osmosis can support energy management using pressure amplification. An energy conversion requirement for a fluid-based energy management system is determined, where the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

A pressure amplification block diagram 500 using reverse osmosis is shown. A cylinder 510 can include a piston 512. The diameter of the cylinder or the piston can include a diameter Phi1 516. A pressure P1 514 can be exerted on the piston. The pressure P1 can be generated using a pump-turbine subsystem. In embodiments, the pressure P1 can include osmotic pressure as transmitted to diameter Phi2 540. The pressure can include a constant pressure. The piston can pressurize a liquid or gas within a pipe 520. The pipe can include a diameter Phi2 540, where ϕ₂ can be less than ϕ₁, much less than ϕ₁, and so on. The pipe 520 can include a selectively permeable membrane 530. In embodiments, the selectively permeable membrane can include a dense layer of polymer matrix. The selectively permeable membrane can enable osmosis. On one side of the selectively permeable membrane, reverse osmosis water 522 can be drawn from the pipe 520. The reverse osmosis water can be removed from the pipe at a constant rate of flow. On the other side of the selectively permeable membrane, solvent or solute 532 can be removed. The solvent can include water or another solvent. The solute can include salt from seawater or brackish water, bacteria or viruses, pollutants, etc. Flow of the solute or solvent can be controlled by valve 534. Flow of reverse osmosis water 522 can be controlled by valve 536. In embodiments, the reverse osmosis membrane has a large surface area.

The selectively permeable membrane such as the dense polymer matrix can allow the flow of water from the solvent/solute, leaving the solute. The osmotic process is enhanced by the osmotic pressure. In embodiments, the osmotic pressure is measured at 2-17 bar for brackish water, 40-82 bar for seawater, and so on. This water cycling technique can be used for energy storage and recovery. In embodiments, remaining potential energy in brackish water can still be at high pressure after clean water has been delivered across the reverse osmosis membrane 530. The remaining potential energy can be captured and stored by compressing a gas such as air, liquifying a gas, and so on. Energy can be recovered from the compressed gas using the pump-turbine subsystem. In embodiments, the pump-turbine subsystem can be operating in a turbine mode.

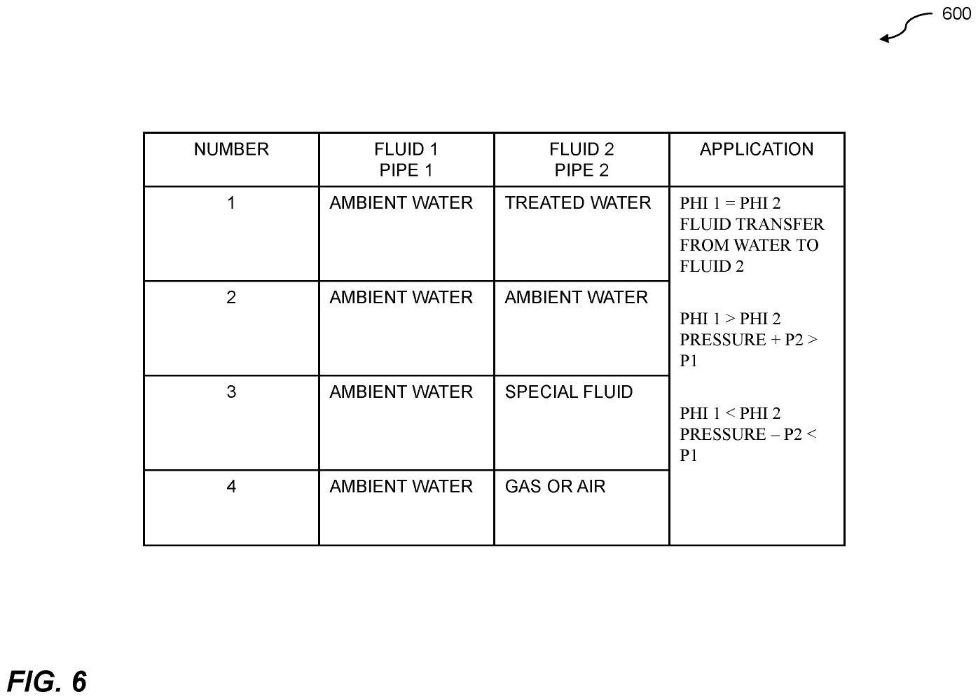

FIG. 6 is a table for pressure amplification pipes. Pipes of various sizes can be used for pressure amplification or deamplification. A pump can be operated at an optimal pressure and an optimal flow rate. By choosing one or more pressure amplification pipes with small diameters, high amplification factors can be attained, and while choosing one or more pressure amplification pipes with large diameters, high deamplification can be obtained. Pressure amplification or pressure deamplification can be used for energy management. An energy conversion requirement for a fluid-based energy management system is determined, where the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered where the delivering is accomplished using the pump-turbine subsystem connected to one or more pressure amplification pipes.

The table 600 shows applications based on pressure amplification pipes. As mentioned above, a pump can be operated at an optimal pressure and at an optimal flow rate. The optimal pressure or the optimal flow rate can be determined based on the type of pump, the capacity of the pump, the fluid to be transferred by the pump, and so on. In embodiments, a first fluid, fluid 1, can be pumped through pipe 1 at a pressure P₁ and a flow rate ϕ₁. The first fluid, fluid 1, can include ambient water. A second fluid, fluid 2, can be amplified or deamplified by using a pressure amplification pipe, pipe 2, to achieve a pressure P₂ and a flow rate ϕ₂. Four fluid combination scenarios are shown. The second fluid, fluid 2, can include treated water; ambient water; a special fluid such as Freon or liquid air; gas or air; and so on. There are various applications to which the pressure amplification can be applied. An application where the flow rates ϕ₁=ϕ₂ can be used for fluid transfer. The fluid transfer can include a fluid transfer between ambient water and a second fluid. An application can include flow rates ϕ₁>ϕ₂, where pressure+P₂>P₁. A further application can include flow rates ϕ₁<ϕ₂, where pressure−P₂<P₁.

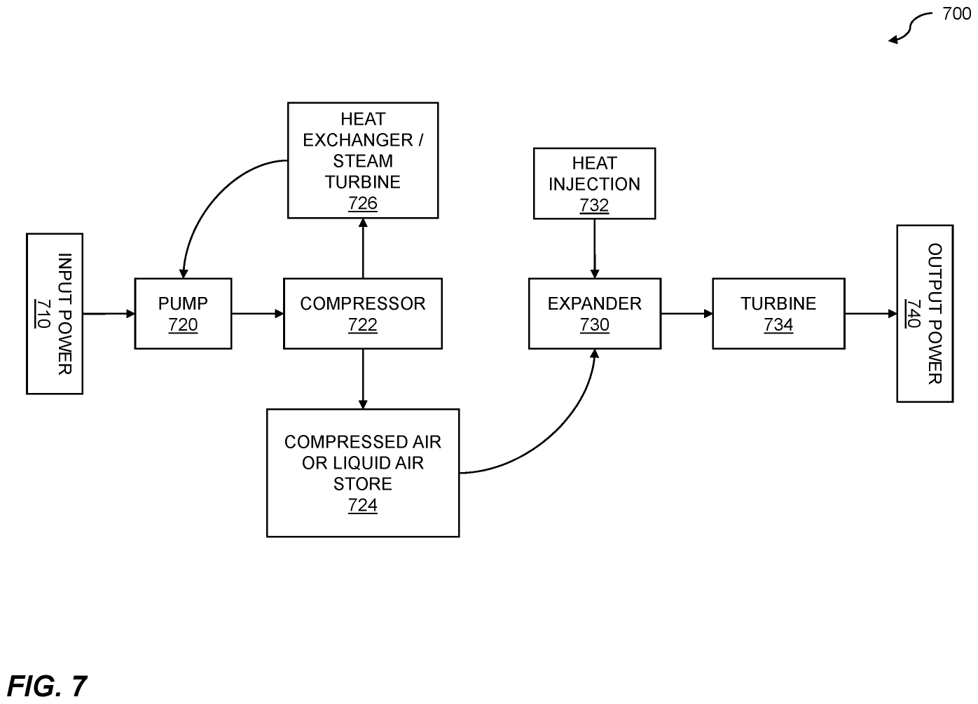

FIG. 7 shows energy storage and recovery 700. Energy management can include storing energy for a period of time where the period of time can include a short-term basis, a long-term basis, and so on. The stored energy can be recovered and delivered to meet one or more energy load requirements. Energy storage and recovery can enable energy management using pressure amplification. An energy conversion requirement for a fluid-based energy management system is determined, wherein the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

Input power 710 can include energy sources such as grid energy from sources including coal or natural gas, hydro, and nuclear, and renewable energy sources such as solar, wind, tidal, and wave action. Energy produced from some renewable energy sources can be intermittent. Solar or wind generation relies on the presence of sunlight or wind, respectively. Solar generation is at a minimum on a cloudy day, and substantially zero at night, while wind generation is substantially zero when the wind is calm. Since energy load requirements persist even in the absence of sunlight or wind, for example, energy generated intermittently can be stored. Energy storage can be based on electrical storage, chemical storage, pressure storage, and so on. In embodiments, energy can be stored by using a pump 720. The pump can include and electrically operated pump, a pump driven by a turbine, and the like. The pump can drive a compressor 722 which can be used to store energy in various forms. In embodiments, the compressor can be used to store energy as compressed air or liquid air. The compressed air or the liquid air can be stored in a store 724. The compressor can also be used to generate steam. In embodiments, the compressor can drive a heat exchanger/steam turbine 726. The steam can be used to spin the turbine, which can be used to operate the pump 720. Energy such as excess heat, including latent heat, can be collected using the heat exchanger. In embodiments, the collected energy can be used to preheat compressed air that can be used to spin a turbine.

The compressed air or liquid air can be coupled to an expander 730. The expander can be coupled to a turbine 734, where the turbine can be spun by the release of the compressed air. As compressed air expands or is released, the compressed air cools. The result of the cooling air can be to precipitate out any moisture that can be contained within the compressed air. The precipitating moisture can cause the turbine to freeze or ice up due to an accumulation of frost within the turbine. To prevent icing up of the turbine, heat collected by the heat exchanger can be injected 732 into the expander 730. The turbine can be coupled to or can include a generator (not shown). The generator can produce output power 740. The output power can be used to meet increased power load requirements. The output power can be generated from the stored energy, where the stored energy can be generated by the intermittent power sources. The output power that can be generated from the stored energy after a period of time that is based on a short-term bases or a period of time that is based on a long-term basis.

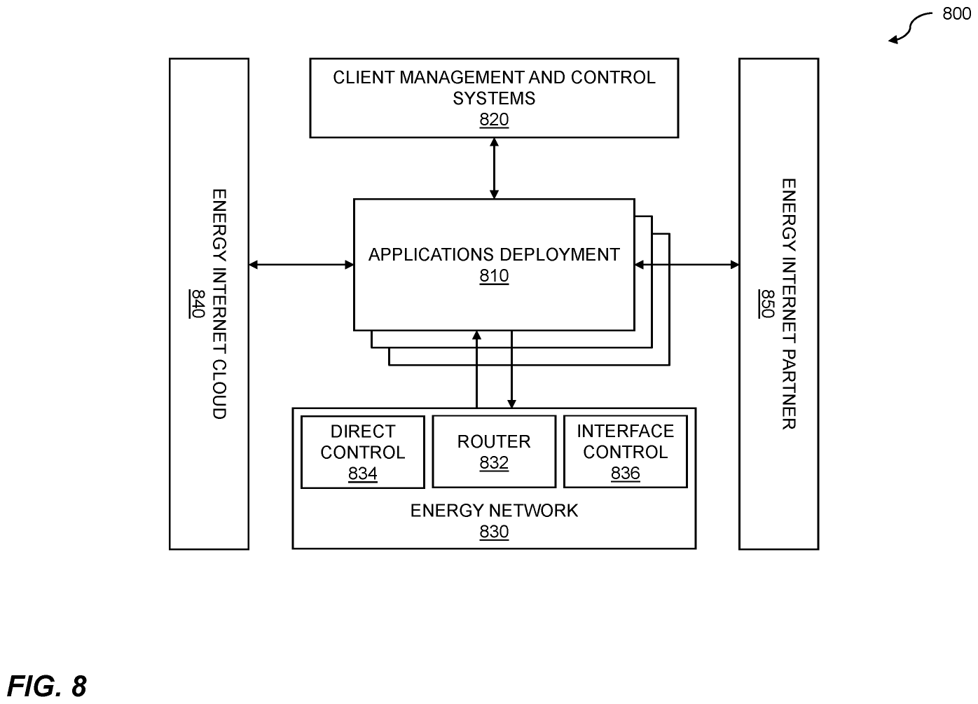

FIG. 8 illustrates an energy internet block diagram. An energy internet 800 enables energy management using pressure amplification. An energy conversion requirement for a fluid-based energy management system is determined, wherein the energy management system includes a pump-turbine subsystem connected to one or more pressure amplification pipes. Energy is provided to the energy management system, based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes. The pump-turbine subsystem is operated at an optimal pressure-performance point for the pump-turbine subsystem. The energy internet can include applications deployment 810. The applications deployment for an energy internet can include a cluster, where the cluster includes one or more application programming interfaces (APIs) for handling data, policies, communications, control, and so on. The data can include energy storage, pump-turbine storage, energy from water power, grid energy, etc. The data can include information from energy generators, partners, and so on. The data can further include third-party data from parties including energy consumers such as oil rigs; solar, wind, tidal, or wave-action farms; datacenters; and the like.

Applications deployment can communicate with client management and control systems 820. The management can include infrastructure management, microgrid management, operating management, automated controls, and so on. The management can include management of client legacy equipment. The communicating between applications deployment and client management and control systems can include collecting data from one or more points of energy generation, one or more points of energy load, etc. The communicating can further include sending one or more energy control policies. The energy control policies can be based on the energy, energy information, energy metadata, availability of a large-scale energy storage subsystem, and the like. The energy internet can include an energy network 830. The energy network can include one or more energy routers 832, direct control 834, interface control 836, and so on. An energy router 830 can include digital switches for routing energy from a point of energy generation to a point of energy load. An energy router can be coupled to one or more direct control 834 sensors for detecting switch status, point of source status, point of load status, etc. An energy router can be coupled to direct control actuators for steering energy from one or more points of source to a given point of load. An energy router can be further connected to one or more third-party interface control 836 sensors and third-party interface control actuators. The interface control sensors and interface control actuators can be coupled to equipment such as legacy equipment which may not be directly controllable.

The energy internet (EI) can include an energy internet cloud 840. The energy internet cloud can include an energy internet ecosystem, an energy internet catalog, and so on. The energy internet cloud can include an energy internet secure application programming interface (API) through which the EI cloud can be accessed. The EI ecosystem can include third-party applications such as an application or app store, app development and test techniques, collaboration, assistance, security, and so on. The EI cloud can include an EI catalog. The EI catalog can include technology models, plant and equipment information, sensor and actuator data, operation patterns, etc. The EI cloud can include tools or “as a service” applications such as learning and training, simulation, remote operation, and the like. The energy internet can include energy internet partners 850. The EI partners can provide a variety of support techniques including remote management, cloud support, cloud applications, learning, and so on.

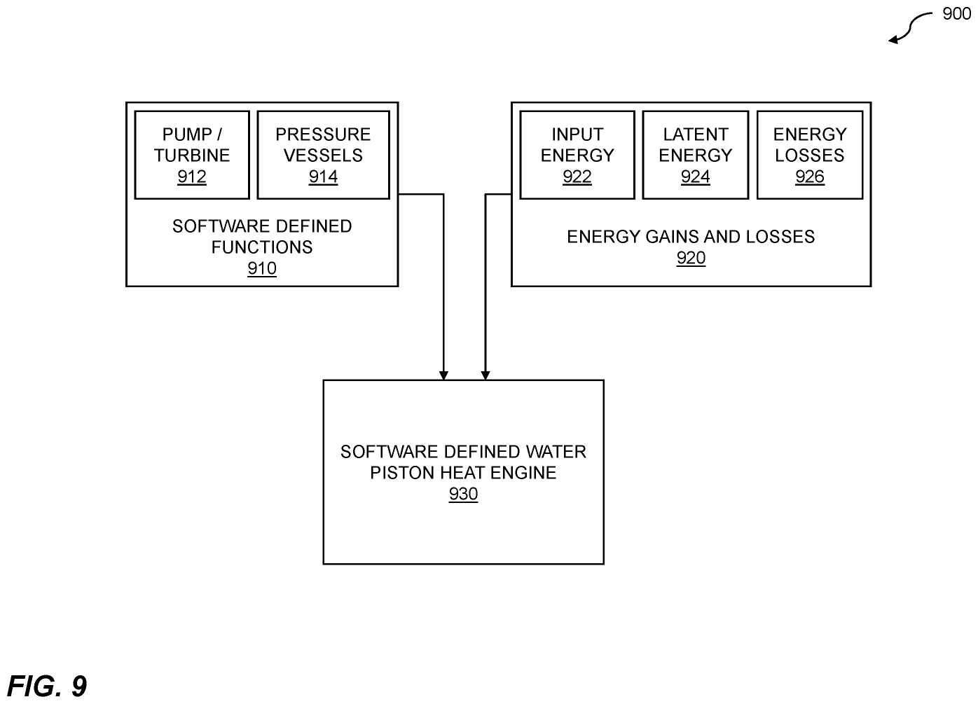

FIG. 9 shows a software-defined water piston engine. Energy can be generated, stored, recovered, transformed, delivered, and so on, to meet energy load requirements. Energy storage can be accomplished when a surplus of energy is being generated from energy sources including renewable energy sources such as wind, solar, tidal, wave-action, and so on. The energy can be stored on a short-term basis such as a length of time substantially less than one week, or on a long-term basis such as a length of time substantially more than one day. The energy transforming and delivering can be used for energy management using pressure amplification. An energy conversion requirement for a fluid-based energy management system is determined, where the energy management system includes a pump-turbine subsystem connected to one or more pressure amplification pipes. Energy is provided to the energy management system based on the energy conversion requirement. The energy is transformed using the pump-turbine subsystem connected to one or more pressure amplification pipes. The energy that was transformed is delivered, where the delivering is accomplished using the pump-turbine subsystem connected to one or more pressure amplification pipes.

A software-defined water piston heat engine 900 is shown. The water piston heat engine includes one or more software-defined functions 910. The one or more software-defined functions can configure or control energy management system components, subsystem components, etc. The software-defined functions can include a pump-turbine function 912. The pump-turbine function can be used to control components such as one or more pumps, one or more turbines, and so on. The pump-turbine function can include one or more pump-turbine subsystems. Embodiments include operating the pump-turbine subsystem at an optimal pressure-performance point for the pump-turbine subsystem. An optimum pressure-performance point can be determined using one or more processors. The pump-turbine function can comprise physical components, moving components, etc. The software-defined functions can include one or more pressure vessels 914. The one or more pressure vessels can be used to store energy within a pressurized fluid, a pressurized gas, and the like. The one or more pressure vessels can include above-ground tanks, below-ground tanks, caverns such as salt caverns, unused oil infrastructure such as unused oil wells, etc.

The water piston heat engine can include energy gains and losses 920. Energy gains can include input energy 922. The input energy can include energy that can be input for storage. The input energy can include grid energy, locally generated energy, renewable energy, and so on. Energy gains can include latent energy 924. Latent energy can be captured from phase changes such as a change from a gas to a liquid, from a liquid to a solid, and so on. The latent energy can be stored. The water piston heat engine can include energy losses 926. Energy losses can include pressure losses from pressurized vessels, temperature losses, electrical charge leakage, and so on. The system 900 includes a software-defined water piston heat engine (WPHE) 930. The software-defined WPHE can use software to configure the software defined functions, to control energy storage and recover, and so on. The WPHE can include an energy management system that can be operated by an energy management control system. The energy management control system can add or remove energy generation subsystems or energy storage subsystems as needed. The energy management control system can support hot-swapping of one or more subsystems. Hot-swapping subsystems can include replacing faulty subsystems, swapping out subsystems for maintenance, and the like. In embodiments, the energy management control system can control coupling of the energy, the pump-turbine subsystem, and the one or more pressure amplification pipes. The energy management control system such as the fluid-based energy management system include storing energy for a period of time. The period of time can include a short-term basis or a long-term basis. In embodiments, the short-term basis can be an integer number of seconds, minutes, hours, or days, wherein the integer number of seconds, minutes, hours, or days comprises a length of time substantially less than one week. Other time bases can be used. In other embodiments, the long-term basis can be an integer number of weeks, months, seasons, or years, wherein the integer number of weeks, months, seasons, or years comprises a length of time substantially more than one day.

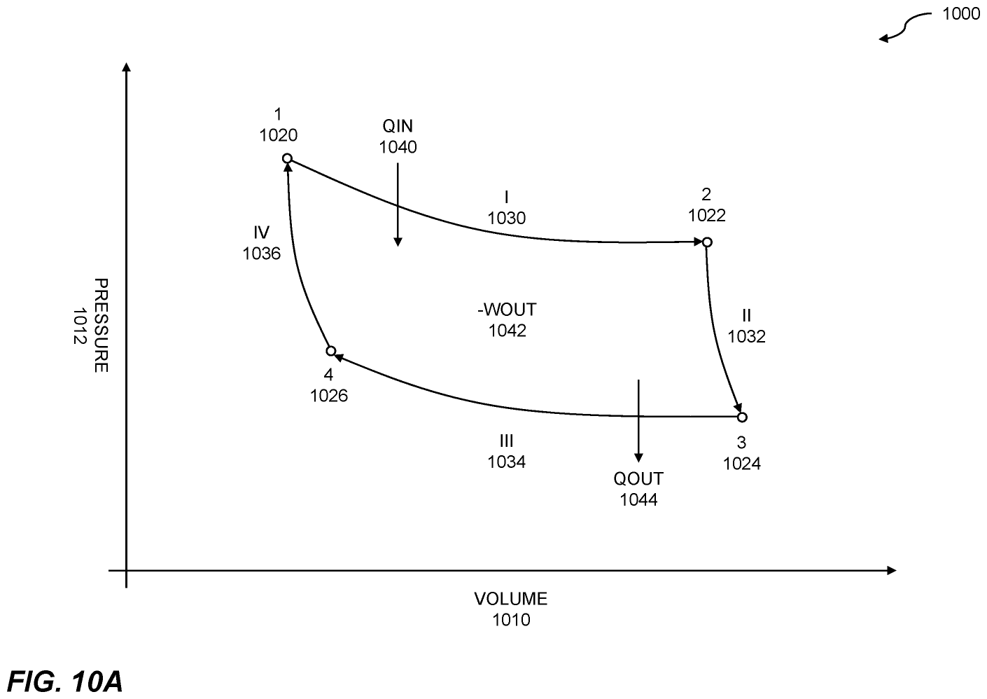

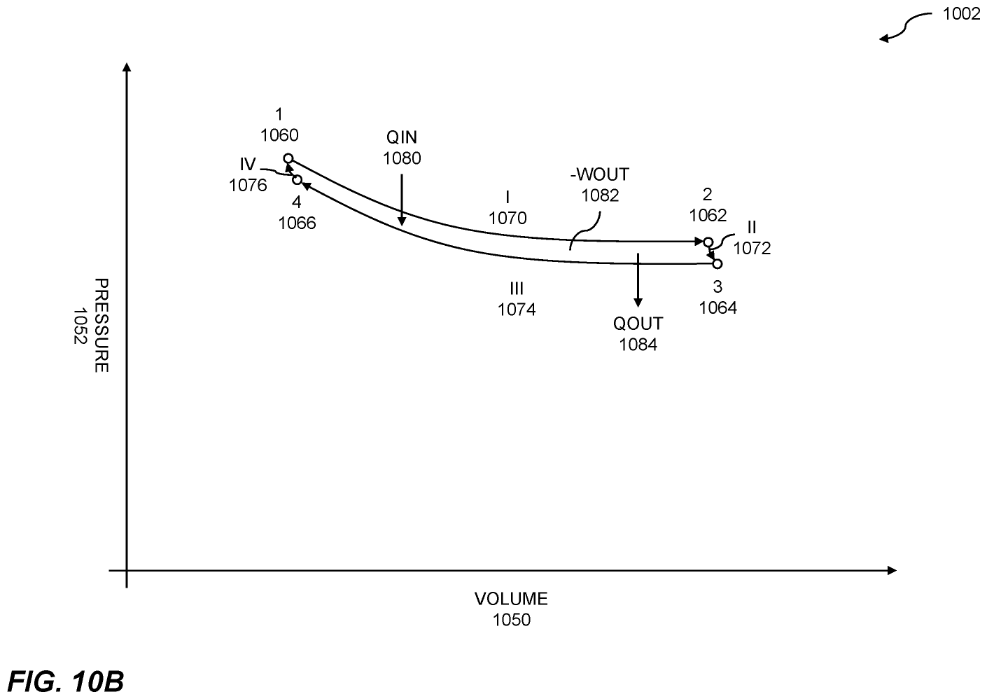

FIG. 10A illustrates adiabicity in a heat transfer cycle. An adiabatic process can occur when neither heat nor mass of a material is transferred between a given thermodynamic system and the environment surrounding the thermodynamic system. “Adiabicity” can describe a quality of the adiabatic process. For the techniques described herein, an adiabatic process with adiabicity equal to zero percent is described as perfectly isothermal, while an adiabatic process with adiabicity equal to 100 percent is described as perfectly adiabatic. Adiabicity in a heat transfer cycle supports energy storage and management using piping. An energy source is connected to a pump-turbine energy management system, where the pump-turbine energy management system includes a pump-energy storage subsystem. Energy from the energy source is stored in the pump-energy storage subsystem. One or more processors are used to calculate a valve-based flow control setting for recovering energy from the pump-energy storage subsystem. One or more valves in the pump-energy management system are energized, where the energizing enables energy recovery. Energy is recovered from the pump-energy storage subsystem using a pump-turbine recovery subsystem enabled by the one or more valves that were energized.

An isothermal adiabatic process can be achieved by adding heat to an endothermic portion of the cycle, such as expansion, and/or extracting heat from an exothermic portion of the cycle, such as compression. Excess heat and excess cooling, both of which would normally be wasted and would move a process out of an isothermal cycle, can be harnessed using a waste-heat recovery subsystem that includes one or more heat exchangers. In embodiments, the one or more heat exchangers enable converting water to steam. The water to steam conversion can be accomplished by spraying cold water into an exothermic process to maintain isothermality in an adiabatic system. In embodiments, the one or more heat exchangers enable converting water to ice. The water to ice conversion can be accomplished by spraying hot water into an endothermic process to maintain isothermality in an adiabatic system. In an adiabatic system, PV^{Y}=k, where P is pressure, V is volume, k is a constant of adiabicity, and gamma (γ) is a volumetric exponent that typically ranges from 1 to 1.4, where γ=1.0 represents an isothermal or near isothermal process and γ=1.4 represents an adiabatic or near adiabatic process. As can be appreciated by one skilled in the art, perfectly isothermal or adiabatic processes are not practiced in typical thermodynamic structures, but processes can nonetheless be referred to as “isothermal” or “adiabatic” when they approach the theoretical limits within 10% to 30%.

The figure shows a pressure-volume (PV) diagram 1000. A PV diagram can be used to show changes in pressure 1012 versus volume 1010 for one or more thermodynamic processes. A cycle, such as a heat transfer cycle, can be based on the one or more thermodynamic processes. One lap around the cycle can complete the cycle, where the completed cycle can result in no net change of system state. With reference to the PV diagram, at the end or completion of the cycle, the thermodynamic system state returns to a pressure and a volume equal to the pressure and the volume of the system at the beginning of the cycle. Four states are shown: state 1 1020, state 2 1022, state 3 1024, and state 4 1026. Each state 1 through 4 represents a pressure and a corresponding volume. While four states are shown, other numbers of states may be present for a given cycle. A path between two states can represent a process. Four processes are shown: process I 1030, process II 1032, process III 1034, and process IV 1036. While four processes are shown, other numbers of processes may be present within a given cycle.

A given process can affect a system pressure, a system volume, or both a system pressure and a system volume. For the heat transfer cycle shown, the processes can be isothermal such as process I and process III, or adiabatic such as process II and process IV. In general, the four processes shown can include isothermal expansion, such as between points 1 and 2; reversible adiabatic or isentropic expansion, such as between points 2 and 3; reversible isothermal compression, such as between points 3 and 4; and reversible adiabatic or isentropic compression, such as between points 4 and 1. Using the first law of thermodynamics, for a closed system, an amount of internal energy of the closed system can be calculated based on a quantity of input heat, such as input heat qin 1040 minus an amount of work performed by the system, such as −wout 1042. Any heat removed from the system, such as output heat qout 1044 can be determined to be equal to the quantity of input heat minus work.

FIG. 10B illustrates an isothermal heat transfer cycle. A cycle of a thermodynamic system can include one or more thermodynamic processes. The thermodynamic processes can include isothermal processes and adiabatic processes. When the adiabicity of adiabatic processes is nearly equal to zero, then the thermal dynamic system can be described approximately as an isothermal system. An isothermal heat transfer thermodynamic system can support energy storage and management using piping. An energy source is connected to a pump-turbine energy management system. The pump-turbine energy management system includes a pump-energy storage subsystem. Energy from the energy source is stored in the pump-energy storage subsystem. Processors are used to calculate a valve-based flow control setting for recovering energy from the pump-energy storage subsystem. Valves in the pump-energy management system are energized to enable energy recovery. Energy is recovered from the pump-energy storage subsystem using a pump-turbine recovery subsystem enabled by the energized valves.

A pressure-volume (PV) diagram is shown in the FIG. 1002. The PV diagram can plot pressure versus volume, and can show one or more states, where each state 1 through 4 comprises a pressure 1052 and a corresponding volume 1050. Four states are shown: state 1 1060, state 2 1062, state 3 1064, and state 4 1066. While four states are shown, other numbers of states may be present for a given cycle. A path between two states can represent a process. A process can include an isothermal process or an adiabatic process. A given process can impact the thermodynamic system by changing pressure, volume, or both pressure and volume. Four processes are shown: process I 1070, process II 1072, process III 1074, and process IV 1076. While four processes are shown, other numbers of processes may be present within a given cycle. For the isothermal heat transfer cycle shown, process I and process III can be isothermal. The adiabatic processes, process II and process IV can be as close to zero possible. The adiabatic processes II and IV can have an adiabicity nearly equal to zero. Recall that for a closed thermodynamic system, an amount of internal energy of the closed system can be calculated based on a quantity of input heat, such as input heat qin 1080 minus an amount of work performed by the system, such as −wout 1082. Any heat removed from the system, such as output heat qout 1084 can be determined to be equal to the quantity of input heat minus work.

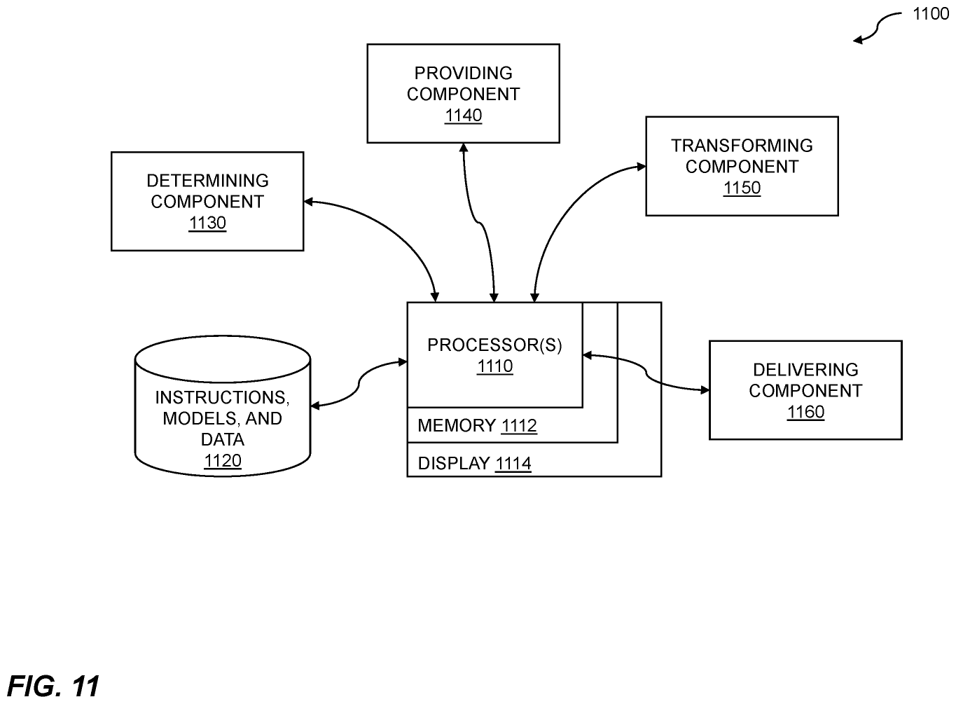

FIG. 11 is a system diagram for energy management. The energy management uses pressure amplification. An energy conversion requirement for a fluid-based energy management system is determined. The energy management system includes a pump-turbine subsystem connected to one or more pressure amplification pipes. The energy conversion requirement can be based on one or more energy loads, where the energy loads can include domestic or household loads, industrial loads, manufacturing loads, municipal loads, regional loads, and so on. Energy is provided to the energy management system, based on the energy conversion requirement. The energy that is provided can include electrical energy, fluid energy, chemical energy, thermal energy, etc. The energy is transformed using the pump-turbine subsystem connected to one or more pressure amplification pipes. The energy can be transformed to electrical energy. The pump-turbine subsystem can comprise a single pump-turbine component or a separate pump component and a separate turbine component. The energy that was transformed is delivered. The delivering is accomplished using the pump-turbine subsystem connected to one or more pressure amplification pipes.

The system 1100 can include one or more processors 1110 and a memory 1112 which stores instructions. The memory 1112 is coupled to the one or more processors 1110, wherein the one or more processors 1110 can execute instructions stored in the memory 1112. The memory 1112 can be used for storing instructions; for storing databases of energy subsystems, modules, or peers for system support; and the like. Information regarding energy management using pressure amplification can be shown on a display 1114 connected to the one or more processors 1110. The display can comprise a television monitor, a projector, a computer monitor (including a laptop screen, a tablet screen, a netbook screen, and the like), a smartphone display, a mobile device, or another electronic display. The system 1100 includes instructions, models, and data 1120. The data can include information on energy sources, energy conversion requirements, metadata about energy, and the like. In embodiments, the instructions, models, and data 1120 are stored in a networked database, where the networked database can be a local database, a remote database, a distributed database, and so on. The instructions, models, and data 1120 can include instructions for obtaining operating data from a plurality of fluid-based energy modules, one or more operating goals for the plurality of fluid-based energy modules, instructions for analyzing operating data, instructions for controlling the operation of energy modules, etc.

The system 1100 includes a determining component 1130. The determining component 1130 can determine an energy conversion requirement for a fluid-based energy management system. The energy management system includes a pump-turbine subsystem connected to one or more pressure amplification pipes. The pressure amplification pipes can comprise pipes of substantially similar cross-sectional dimensions or substantially different cross-sectional dimensions. The pressure amplification can be based on the cross-sectional dimensions of pressure amplification pipes. In embodiments, the energy conversion requirement can include operation of a pump within the pump-turbine subsystem and fluid delivery out of the one or more pressure amplification pipes. The energy conversion requirement can be based on one or more energy loads. In other embodiments, the energy conversion requirement can include fluid pressure delivered into at least one pipe of the one or more pressure amplification pipes and turbine operation. The turbine can be coupled to other components such as a pump, a generator, and so on.

The system 1100 includes a providing component 1140. The providing component 1140 can providing energy to the energy management system, based on the energy conversion requirement. The energy that can be provided can include electrical energy which can be used to operate a pump, a pump-turbine, and so on. The energy can be provided based on energy transferred from one or more liquids, energy based on pressure differentials, energy transferred from one or more gases, etc. The system 1100 includes a transforming component 1150. The transforming component 1150 can transform the energy using the pump-turbine subsystem connected to one or more pressure amplification pipes. The transforming energy can include transforming energy stored in pressure differentials, one or more gases, or one or more liquids into another energy form. In embodiments the energy form can include electrical energy. The system 1100 includes a delivering component 1160. The delivering component 1160 can deliver the energy that was transformed, where the delivering is accomplished using the pump-turbine subsystem connected to one or more pressure amplification pipes. The pump-turbine subsystem can deliver energy in the form of electrical energy. The energy can be delivered to one or more points of load. The delivering can include delivering energy via an electrical grid, a local electrical grid, an energy Internet, and the like.

Disclosed embodiments include a computer program product embodied in a non-transitory computer readable medium for energy management, the computer program product comprising code which causes one or more processors to perform operations of: determining an energy conversion requirement for a fluid-based energy management system, wherein the energy management system includes a pump-turbine subsystem connected to one or more pressure amplification pipes; providing energy to the energy management system, based on the energy conversion requirement; transforming the energy, using the pump-turbine subsystem connected to one or more pressure amplification pipes; and delivering the energy that was transformed, wherein the delivering is accomplished using the pump-turbine subsystem connected to one or more pressure amplification pipes.

Disclosed embodiments include a computer system for energy management comprising: a memory which stores instructions; one or more processors coupled to the memory wherein the one or more processors, when executing the instructions which are stored, are configured to: determine an energy conversion requirement for a fluid-based energy management system, wherein the energy management system includes a pump-turbine subsystem connected to one or more pressure amplification pipes; provide energy to the energy management system, based on the energy conversion requirement; transform the energy, using the pump-turbine subsystem connected to one or more pressure amplification pipes; and deliver the energy that was transformed, wherein the delivering is accomplished using the pump-turbine subsystem connected to one or more pressure amplification pipes.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more substeps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for energy management comprising:
determining an energy conversion requirement for a fluid-based energy management system, wherein the energy management system includes a pump-turbine subsystem connected to one or more pressure amplification pipes;
providing energy to the energy management system, based on the energy conversion requirement;
transforming the energy, using the pump-turbine subsystem connected to one or more pressure amplification pipes; and
delivering the energy that was transformed, wherein the delivering is accomplished using the pump-turbine subsystem connected to one or more pressure amplification pipes.

2. The method of claim 1 further comprising operating the pump-turbine subsystem at an optimal pressure-performance point for the pump-turbine subsystem.

3. The method of claim 2 wherein the energy conversion requirement includes operation of a pump within the pump-turbine subsystem and fluid delivery out of the one or more pressure amplification pipes.

4. The method of claim 3 wherein the pump is driven by electrical energy.

5. The method of claim 2 wherein the energy conversion requirement includes fluid pressure delivered into at least one pipe of the one or more pressure amplification pipes and turbine operation.

6. The method of claim 5 wherein the turbine operation is used to drive electrical energy generation.

7. The method of claim 5 wherein the fluid pressure delivered comprises a vacuum.

8. The method of claim 1 wherein a first pressure amplification pipe within the one or more pressure amplification pipes comprises a rigid, mechanical connection between a first piston of a first pipe and a second piston of a second pipe.

9. The method of claim 8 wherein the mechanical connection, the first piston, and the second piston are disposed rectilinearly.

10. The method of claim 8 wherein the first piston is a first diameter and the second piston is a second diameter.

11. The method of claim 10 wherein the difference between the first diameter and the second diameter provides a pressure amplification factor.

12. The method of claim 10 wherein the first piston is driven by a first fluid and the second piston is driven by a second fluid.

13. The method of claim 12 wherein the first fluid is ambient water delivered at an optimal pressure-performance point for a pump of the pump-turbine subsystem.

14. The method of claim 12 wherein the first fluid and the second fluid are different fluids.

15. The method of claim 12 wherein the second fluid is a vacuum.

16. The method of claim 1 wherein the energy management system is operated by an energy management control system.

17. The method of claim 16 wherein the energy management control system controls coupling of the energy, the pump-turbine subsystem, and the one or more pressure amplification pipes.

18. The method of claim 1 wherein the fluid-based energy management system includes storing energy for a period of time.

19. The method of claim 18 wherein the period of time is a short-term basis.

20. The method of claim 19 wherein the short-term basis is an integer number of seconds, minutes, hours, or days, wherein the integer number of seconds, minutes, hours, or days comprises a length of time substantially less than one week.

21. The method of claim 18 wherein the period of time is a long-term basis.

22. The method of claim 21 wherein the long-term basis is an integer number of weeks, months, seasons, or years, wherein the integer number of weeks, months, seasons, or years comprises a length of time substantially more than one day.

23. A computer program product embodied in a non-transitory computer readable medium for energy management, the computer program product comprising code which causes one or more processors to perform operations of:
determining an energy conversion requirement for a fluid-based energy management system, wherein the energy management system includes a pump-turbine subsystem connected to one or more pressure amplification pipes;
providing energy to the energy management system, based on the energy conversion requirement;
transforming the energy, using the pump-turbine subsystem connected to one or more pressure amplification pipes; and
delivering the energy that was transformed, wherein the delivering is accomplished using the pump-turbine subsystem connected to one or more pressure amplification pipes.

24. A computer system for energy management comprising:
a memory which stores instructions;
one or more processors coupled to the memory wherein the one or more processors, when executing the instructions which are stored, are configured to:
determine an energy conversion requirement for a fluid-based energy management system, wherein the energy management system includes a pump-turbine subsystem connected to one or more pressure amplification pipes;
provide energy to the energy management system, based on the energy conversion requirement;
transform the energy, using the pump-turbine subsystem connected to one or more pressure amplification pipes; and
deliver the energy that was transformed, wherein the delivering is accomplished using the pump-turbine subsystem connected to one or more pressure amplification pipes.
